(19) United States
(12) Patent Application Publication
(10) Pub. No.: US 2010/0035537 A1
(43) Pub. Date: Feb. 11, 2010

(54) AIR CLEANER

(76) Inventor: James HO, Taipei (TW)

Correspondence Address: BIRCH STEWART KOLASCH & BIRCH, PO BOX 747, FALLS CHURCH, VA, 22040-0747, US

(21) Appl. No.: 12/187,871

(22) Filed: Aug. 7, 2008

(51) Int. Cl. F24F 7/00; B03C 3/155; B01D 46/10

(52) U.S. Cl. 454/284; 454/333; 55/327; 96/67

(57) ABSTRACT

An air cleaner, which includes a casing having an enclosed air passage with a ventilation pipe for guiding in outdoor air, a windpipe affixed to one side of the casing for circulation of indoor air, a damper pivotally mounted in between the casing and the windpipe for controlling the passage the casing and the windpipe and flowing direction of air between the casing and the windpipe, and an air filter and a negative ion generator mounted in the windpipe for cleaning air passing through the windpipe.

### BACKGROUND OF THE INVENTION

1. Field of the Invention

The present invention relates to air cleaners and more particularly, to such an air cleaner, which has outdoor air be mixed with indoor air to moderate the temperature before cleaning.

2. Description of the Related Art

Exhaust fans have been intensively used in buildings for ventilation and electric apparatus for dissipation of heat. A regular exhaust fan generally comprises a housing and a fan mounted in the housing. When electric power is connected to the fan, the fan is rotated to expel indoor air to the outside of the room or house, or to draw outdoor air into the inside of the room or house, thereby lowering the temperature and dissipating heat. However, regular exhaust fans cannot clean air. Because influenza, SARS, and many other diseases spread by means of air, breathing spoiled air may cause a disease.

Therefore, air cleaners are developed to clean air. A conventional air cleaner has an air inlet an air outlet, and multiple layers of filter means set in between the air inlet and the air outlet to remove solid matters from air passing through. However, in a cold place, the temperature of outdoor air is much lower than the temperature of indoor air. Directly guiding cold outdoor air into the inside of the house causes lowering of the temperature of indoor air. Quick lowering of the temperature of indoor air causes people in the house to feel uncomfortable. In order to increase the temperature, an electric heater or the like may be necessary.

### SUMMARY OF THE INVENTION

The present invention has been accomplished under the circumstances in view. According to one aspect of the present invention, the air cleaner comprises a casing, the casing having an enclosed air passage and at least one ventilation pipe extending from one end of the enclosed air passage for guiding outside air into the enclosed air passage; a windpipe affixed to one side of the casing for positioning inside a house when the casing is mounted on the outside of the house, the windpipe having two openings in two opposite ends thereof; damper means pivotally mounted in between the casing and the windpipe and adapted to control a passage between the openings of the windpipe and the enclosed air passage of the casing; and air filter means and a negative ion generator mounted in the windpipe and adapted to air passing through the windpipe. By means of controlling the damper means, outdoor air is guided into the windpipe and mixed with indoor air to moderate the temperature, and the mixed air is then cleaned by the air filter means and the negative ion generator. Therefore, clean air of moderate temperature is continuously provided to people inside the house.

According to another aspect of the present invention, an electric fan is mounted inside the windpipe to draw outside air into the windpipe or to expel air to the outside of the house.

### BRIEF DESCRIPTION OF THE DRAWINGS

FIG. 1 is a perspective view of an air cleaner in accordance with 1 the present invention.

FIG. 2 is an exploded view of the air cleaner shown in FIG. 1.

FIG. 3 is a schematic sectional view, illustrating air intake action of the air cleaner.

FIG. 4 is a schematic sectional view illustrating exhaust operation of the air cleaner.

### DETAILED DESCRIPTION OF THE PREFERRED EMBODIMENT

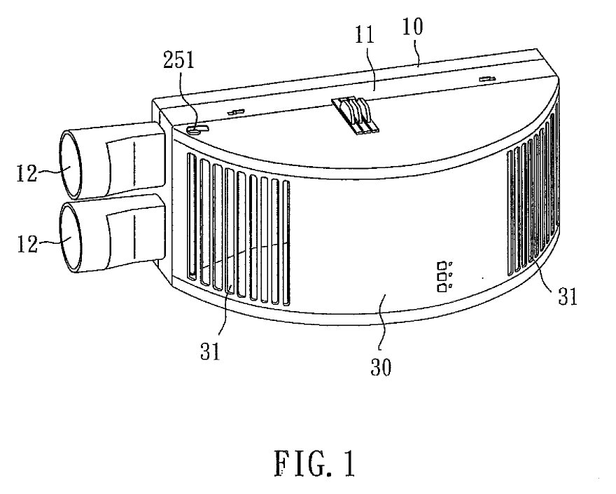

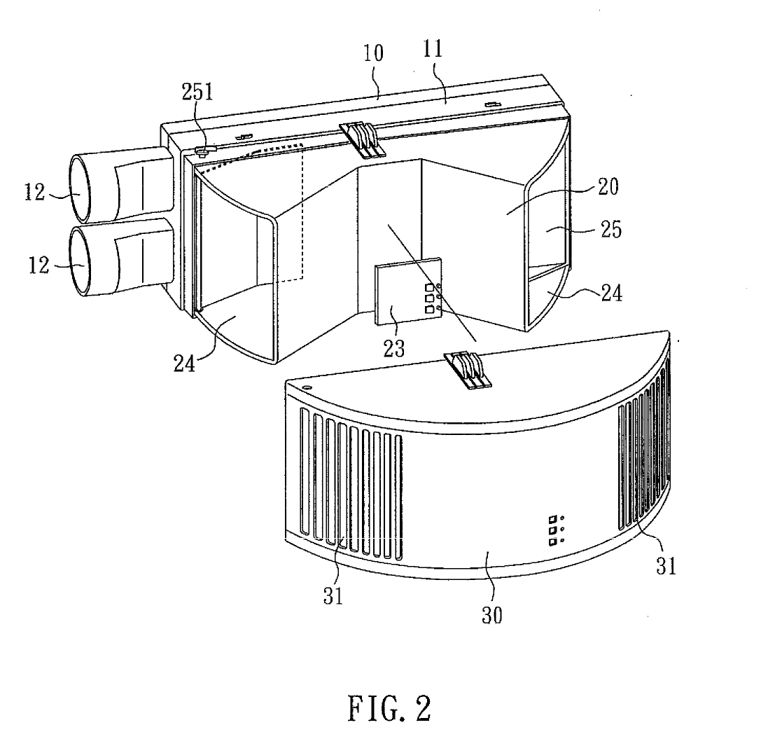

Referring to FIGS. 1 and 2, an air cleaner in accordance with the present invention is shown comprising a casing 10. The casing 10 has an enclosed passage 11, at least one, for example, two ventilation pipes 12 outwardly extending from one end of the enclosed air passage 11, a windpipe 20 provided at one side outside the enclosed air passage 11, an air filter 21 and a negative ion generator 22 mounted inside the windpipe 20, and a control circuit board 23 mounted on the outside wall of the windpipe 20. The air filter 21 is comprised of filter cottons and active carbons and adapted to remove solid matter from air passing through the windpipe 20. The negative ion generator 22 is adapted to generate negative ions to purify air passing through the windpipe 20. The control circuit board 23 is adapted to control the operation of the air cleaner.

Further, the windpipe 20 has two openings 24 defined in the two expanded opposite ends thereof. A damper 25 is pivotally mounted in between the enclosed air passage 11 and one opening 24 of the windpipe 20 adjacent to the ventilation pipes 12. A handle 251 is connected to the damper 25 and disposed outside the casing 10 for operation by the user to bias the damper 25, thereby closing/opening the passage between the enclosed air passage 11 and the associating opening 24 of the windpipe 20. Further, a fan 26 may be mounted inside the windpipe 20 corresponding to the damper 26 (see FIG. 4).

Further, a cover shell 30 is covered on the windpipe 20 of the casing 10, having a plurality of air holes 31 corresponding to the openings 24 of the windpipe 20.

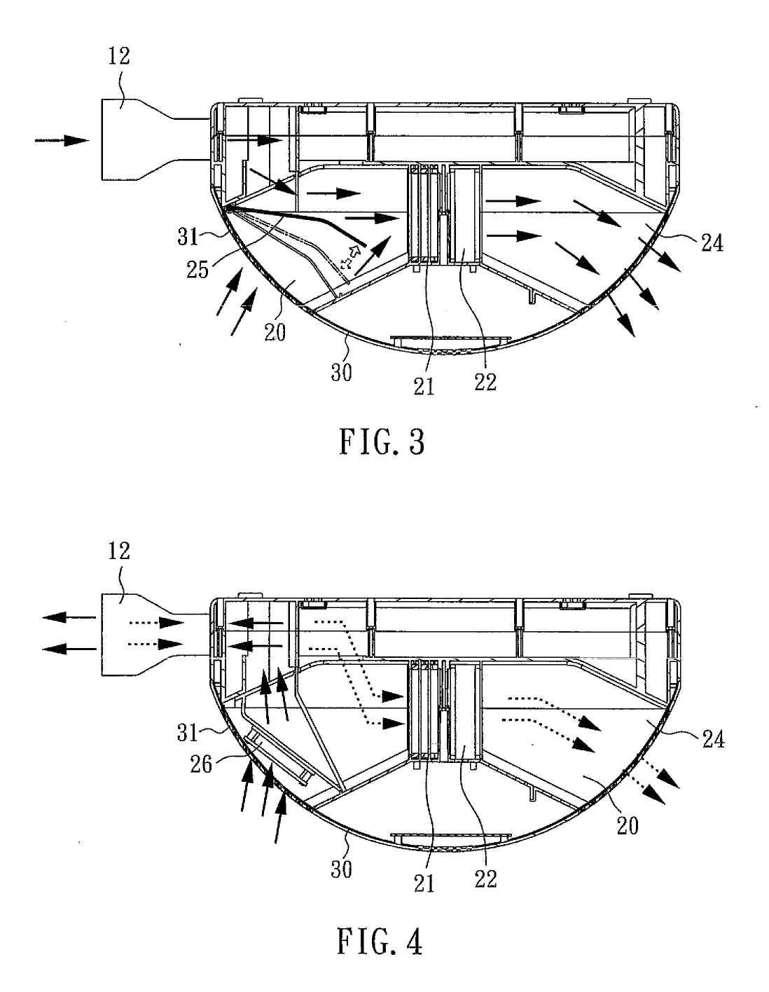

Referring to FIG. 3, when outdoor air enters the ventilation pipes 12 into the enclosed air passage 11, the damper 25 is adjusted to guide outside air into the windpipe 20 for mixing with indoor air that passes from the space inside the room (house) through the air holes 31 into one opening 24 of the windpipe 20. Because outdoor air is mixed with indoor air, the temperature of the mixed air is moderated.

The mixed air is than cleaned by the air filter 21 and the negative ion generator 22 and then the clean air flows out of the other opening 24 of the windpipe 20 into the inside space of the room (house), keeping the air in the room (house) clean and fresh.

Referring to FIG. 4, by means of the effect of the fan 26, indoor air passes over the damper 25 into the enclosed air passage 11 and then to the outdoor space through the ventilation pipes 12.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. An air cleaner comprising:
a casing, said casing having an enclosed air passage and at least one ventilation pipe extending from one end of said enclosed air passage for guiding outside air into said enclosed air passage;
a windpipe affixed to one side of said casing for positioning inside a house when said casing is mounted on the outside of said house, said windpipe having two openings in two opposite ends thereof;
damper means pivotally mounted in between said casing and said windpipe and adapted to control a passage between the openings of said windpipe and the enclosed air passage of said casing; and
air filter means mounted in said windpipe and adapted to remove solid matters from air passing through said windpipe.

2. The air cleaner as claimed in claim 1, further comprising a negative ion generator mounted inside said windpipe.

3. The air cleaner as claimed in claim 1, further comprising a cover shell covering said windpipe, said cover shell having a plurality of air holes corresponding to the openings of said windpipe.

4. The air cleaner as claimed in claim 1, further comprising an air fan mounted inside said windpipe corresponding to said damper means.
